(19) United States
(12) Patent Application Publication
(10) Pub. No.: US 2026/0171848 A1
(43) Pub. Date: Jun. 18, 2026

(54) WIRELESS SENSOR AND RAISING/LOWERING DEVICE INFORMATION COLLECTION SYSTEM

(71) Applicant: Mitsubishi Electric Corporation, Tokyo (JP)

(72) Inventor: Yoshiyuki UCHIDA, Tokyo (JP)

(73) Assignee: Mitsubishi Electric Corporation, Tokyo (JP)

(21) Appl. No.: 18/719,269

(22) PCT Filed: Feb. 10, 2022
(86) PCT No.: PCT/JP2022/005444

§ 371 Date: Jun. 13, 2024

(51) Int. Cl. H02J 50/12; H04W 84/18

(52) U.S. Cl. CPC H02J 50/12; H04W 84/18

(57) ABSTRACT

A wireless sensor and a raising/lowering device information collection system that can suppress an increase in an amount of wiring are provided. The raising/lowering device information collection system includes the wireless sensor that operates by power obtained from a safety circuit when a first contact included in the safety circuit in which a plurality of contacts are connected in series is open in a raising/lowering device, and transmits a radio wave indicating an electrical signal indicating a condition of a voltage of a first contact during operation, and a gateway device that creates information on the first contact based on the radio wave received from the wireless sensor and transmits the information on the first contact to a remote communication device.

### TECHNICAL FIELD

The present disclosure relates to a wireless sensor and a raising/lowering device information collection system.

### BACKGROUND ART

Patent Literature 1 discloses an elevator system. In the elevator system, a safety circuit in which a plurality of contacts that exhibit the function of interlock are connected in series is provided. Each of the plurality of contacts of the safety circuit is provided with an auxiliary contact. The auxiliary contacts open and close in association with the contacts, and thereby the control device of the elevator system can identify the contact that is opened.

### CITATION LIST

### Patent Literature

[PTL 1] JP 2009-023820 A

### SUMMARY OF INVENTION

### Problem to Be Solved by the Invention

In the safety circuit, in order to reduce the amount of wiring, the plurality of contacts are connected in series instead of being connected individually in parallel. However, according to the elevator system disclosed in PL1, wiring for detecting opening and closing of the auxiliary contacts is required. Therefore, the amount of wiring significantly increases.

The present disclosure has been made to solve the aforementioned problem. An object of the present disclosure is to provide a wireless sensor and a raising/lowering device information collection system that can suppress an increase in an amount of wiring.

### Problem to Be Solved by the Invention

A wireless sensor according to the present disclosure measures a condition of a first contact included in a safety circuit in which a plurality of contacts are connected in series in a raising/lowering device. The wireless sensor includes a signal detection unit that detects an electrical signal indicating a condition of a voltage of the first contact; a power acquisition unit that obtains power from the safety circuit when the first contact is open; and a transmission unit that operates by the power obtained by the power acquisition unit, and transmits a radio wave indicating an electrical signal detected by the signal detection unit.

A raising/lowering device information collection system according to the present disclosure includes a wireless sensor that operates by power obtained from a safety circuit when a first contact included in the safety circuit in which a plurality of contacts are connected in series opens in a raising/lowering device, and transmits a radio wave indicating an electrical signal indicating a condition of a voltage of the first contact during operation; and a gateway device that creates information on the first contact based on the radio wave received from the wireless sensor, and transmits the information on the first contact to a remote communication device.

### Advantageous Effects of the Invention

According to the present disclosure, the wireless sensor transmits the radio wave showing the condition of the voltage of the contact by using electric power obtained from the safety circuit. Therefore, an increase in the amount of wiring can be suppressed.

### BRIEF DESCRIPTION OF DRAWINGS

FIG. 1 is a view showing an outline of a raising/lowering device to which a raising/lowering device information collection system in embodiment 1 is applied.

FIG. 2 is a schematic diagram showing a configuration of a wireless sensor of the raising/lowering device information collection system in embodiment 1.

FIG. 3 is a block diagram of the raising/lowering device information collection system in embodiment 1.

FIG. 4 is a flowchart for explaining the first example of the operation of the wireless sensor of the raising/lowering device information collection system in embodiment 1.

FIG. 5 is a flowchart for explaining the first example of the operation of the gateway device of the raising/lowering device information collection system in embodiment 1.

FIG. 6 is a flowchart for explaining the first example of the operation of the raising/lowering device information collection system in embodiment 1.

FIG. 7 is sequence diagram for explaining the first example of the raising/lowering device information collection system in embodiment 1.

FIG. 8 is sequence diagram for explaining the first example of the raising/lowering device information collection system in embodiment 1.

FIG. 9 is sequence diagram for explaining the first example of the raising/lowering device information collection system in embodiment 1.

FIG. 10 is a flowchart for explaining a second example of the operation of the wireless sensor of the raising/lowering device information collection system in embodiment 1.

FIG. 11 is a flowchart for explaining the second example of the operation of the gateway device of the raising/lowering device information collection system in embodiment 1.

FIG. 12 is a flowchart for explaining a second example of the operation of the information center device of the raising/lowering device information collection system in embodiment 1.

FIG. 13 is sequence diagram for explaining the second example of the operation of the raising/lowering device information collection system in embodiment 1.

FIG. 13 is sequence diagram for explaining the second example of the operation of the raising/lowering device information collection system in embodiment 1.

FIG. 13 is sequence diagram for explaining the second example of the operation of the raising/lowering device information collection system in embodiment 1.

FIG. 16 is a view showing a relationship between a wireless sensor and a contact of a raising/lowering device information collection system in the first modification of embodiment 1.

FIG. 17 is a schematic diagram showing a configuration of a wireless sensor of a raising/lowering device information collection system in the second modification of embodiment 1.

FIG. 18 is a hardware configuration diagram of an analysis device of the raising/lowering device information collection system in embodiment 1.

### DESCRIPTION OF EMBODIMENTS

A mode for carrying out the present disclosure will be described in accordance with the accompanying drawings. Note that in each of the figures, the same or corresponding parts are assigned with the same reference signs. Redundant explanation of the parts is simplified or omitted as appropriate.

### First Embodiment

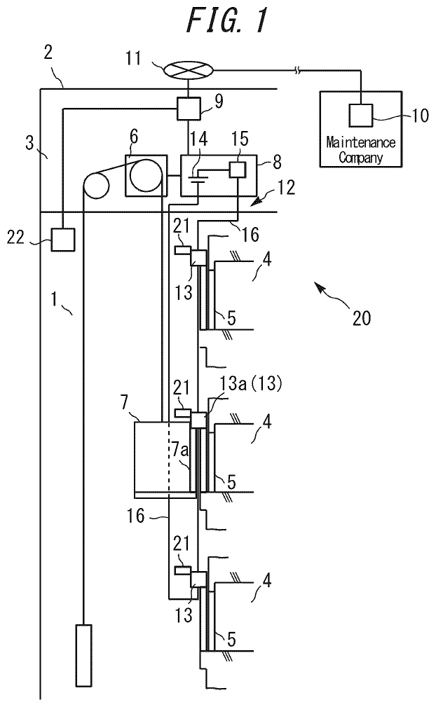

FIG. 1 is a view showing an outline of a raising/lowering device to which a raising/lowering device information collection system in embodiment 1 is applied.

As shown in FIG. 1, for example, the raising/lowering device is an elevator system. In the elevator system, a hoistway 1 penetrates through each floor of a building 2. A machine room 3 is provided directly above the hoistway 1. Each of a plurality of halls 4 is provided on each floor of the building 2. Each of the plurality of halls 4 faces the hoistway 1. A plurality of hatch doors 5 are respectively provided at entrances of the plurality of halls 4.

A traction machine 6 is provided in the machine room 3. A car 7 is provided inside the hoistway 1. The car 7 can be raised and lowered by the traction machine 6. The car 7 includes a car door 7a. A control device 8 is provided in the machine room 3. The control device 8 can generally control the elevator system including the traction machine 6.

A remote communication device 9 is provided in the machine room 3. The remote communication device 9 is electrically connected to the control device 8. The remote communication device 9 can monitor a condition of the elevator system based on information from the control device 8. An information center device 10 is provided in a place away from the building 2. For example, the information center device 10 is provided in a maintenance company for the elevator system. The information center device 10 can communicate with the remote communication device 9 via a communication line network 11. The information center device 10 can grasp the condition of the elevator system based on information from the remote communication device 9.

For example, a safety circuit 12 is a safety chain of the hatch door 5. The safety circuit 12 includes a plurality of contacts 13, a power supply 14, a detector 15, and a conducting wire 16.

The plurality of contacts 13 are respectively provided at the plurality of hatch doors 5 as contacts for interlocking of the hatch doors 5. The contacts 13 are in a closed condition when the corresponding hatch doors 5 are closed. The contacts 13 are in an open condition when the corresponding hatch doors 5 are opened.

For example, the power supply 14 is a direct-current power supply. The power supply 14 is provided inside the control device 8. The detector 15 detects a current. The conducting wire 16 connects each of the plurality of contacts 13, the power supply 14 and the detector 15 in series. In other words, the conducting wire 16 constitutes the safety circuit 12 that is a closed circuit in which each of the plurality of contacts 13, the power supply 14, and the detector 15 are connected in series.

A raising/lowering device information collection system 20 is a system that collects information on a deterioration condition or the like of the contacts 13 included in the safety circuit 12. The raising/lowering information collection system 20 includes a plurality of wireless sensors 21 and a gateway device 22. Further, the raising/lowering device information collection system 20 includes the control device 8, the remote communication device 9, and the information center device 10.

The plurality of wireless sensors 21 are respectively attached to the plurality of contacts 13. The wireless sensor 21 is connected to the safety circuit 12 in parallel with the corresponding contact 13. The wireless sensor 21 obtains power from the safety circuit 12 when the corresponding contact 13 is in an open condition. The wireless sensor 21, by using the power obtained from the safety circuit 12, transmits a radio wave indicating a condition of the contact 13. For example, as the radio wave, a radio wave of a method in conformity with the wireless communication standard with less power consumption, such as Bluetooth (registered trademark) is adopted.

For example, the gateway device 22 is provided inside the hoistway 1. The gateway device 22 can communicate with the plurality of wireless sensors 21 wirelessly. The gateway device 22 can communicate with the remote communication device 9 by wire or wirelessly. The gateway device 22 can communicate with the control device 8 and the information center device 10 via the remote communication device 9. Note that the gateway device 22 may be provided to communicate with the control device 8 without aid of the remote communication device 9.

Note that a plurality of gateway devices 22 may be provided in the elevator system according to a length in a vertical direction of the hoistway 1, or in response to a communication condition with the wireless sensors 21. For example, the two gateway devices 22 may be provided at an upper end portion of the hoistway 1 and a lower end portion of the hoistway 1 respectively. Further, the gateway device 22 may be provided at the car 7.

When the elevator system performs normal operation, the control device 8 controls operation of the car 7 by controlling the traction machine 6. When the car 7 stops at a certain hall 4, the control device 8 opens the car door 7a provided at the car 7. At this time, the car door 7a operates the hatch door 5 to release a lock of the hatch door 5. Further, the car door 7a operates the hatch door 5 so that the contact 13 of the interlock provided at the hatch door 5 of the hall 4 opens in association with the lock. The control device 8 opens the car door 7a after detecting that the contact 13 opens. The hatch door 5 opens with the car door 7a.

In the safety circuit 12, when the contact 13 opens, the detector 15 detects a change in a current value as a result of the contact 13 opening. The detector 15 detects that any of the plurality of contacts 13 opens when the current value of the safety circuit 12 falls below a prescribed detection threshold after a prescribed detection delay time elapses from a time point at which the car door 7a performs an operation of opening the contact 13. The control device 8 detects that any of the contacts 13 opens based on the detection result of the detector 15.

Thereafter, the control device 8 closes the car door 7a. The hatch door 5 closes with the car door 7a. When the hatch door 5 is completely closed, the lock of the hatch door 5 is locked. The contact 13 is closed from the condition of opening in association with the lock. When the control device 8 detects that the contact 13 is closed, the control device 8 detects that the car door 7a and the hatch door 5 are closed. Thereafter, the control device 8 causes the car 7 to run to the hall 4 of another floor.

In the safety circuit 12, when the contact 13 is closed from an open condition, the detector 15 detects a change in the current value due to the closing of the contact 13 and detects that any of the contacts 13 is closed. The control device 8 detects that any of the contacts 13 is closed based on the detection result of the detector 15. By the plurality of contacts 13 being connected in series in this manner, the amount of wiring required for the safety circuit 12 is suppressed.

A resistance value of the wireless sensor 21 is larger than the resistance value of the contact 13. Therefore, when the corresponding contact 13 is closed, a current hardly flows in the wireless sensor 21. When the corresponding contact 13 is opened from a closed condition, the current flowing in the safety circuit 12 passes through the wireless sensor 21. The wireless sensor 21 operates by using the power of the current. In this case, the wireless sensor 21 measures a condition of a voltage of the corresponding contact 13. The wireless sensor 21 transmits a radio wave indicating the condition of the voltage of the contact 13 that is measured. For example, the wireless sensor 21 performs measurement on a prescribed sampling cycle and transmits a radio wave.

At this time, the wireless sensor 21 increases a substantial resistance value of the wireless sensor 21 before a detection delay time set in the detector 15 elapses, and thereby makes the value of the current flowing through the wireless sensor 21 smaller than the detection threshold. Therefore, even in the state in which the safety circuit 12 is not opened, the detector 15 can detect that any of the contacts 13 is opened.

The gateway device 22 receives radio waves from the plurality of wireless sensors 21. The gateway device 22 aggregates information indicated in the received radio waves, and transmits it to the remote communication device 9 as the information on the contacts 13. The remote communication device 9 transmits the information received from the gateway device 22 to the information center device 10 via the communication line network 11. Based on the received information, the information center device 10 performs a maintenance diagnosis such as a deterioration diagnosis, and a failure sign diagnosis of each of the plurality of contacts 13. The information center device 10 reports the information indicating the result of the maintenance diagnosis to a monitoring person of the maintenance company. For example, the monitoring person sets a maintenance plan for the plurality of contacts 13 based on the reported information.

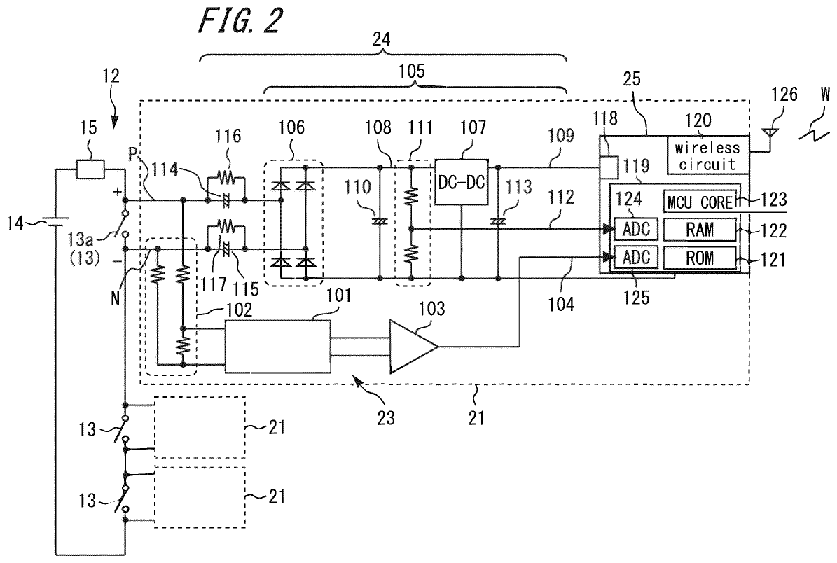

Next, the wireless sensor 21 will be described by using FIG. 2.

FIG. 2 is a schematic diagram showing a configuration of a wireless sensor of the raising/lowering device information collection system in embodiment 1.

Each of the plurality of wireless sensors 21 has a similar configuration. In FIG. 2, the wireless sensor 21 attached to a first contact 13a of the plurality of contacts 13 is described.

A positive side bus P of the wireless sensor 21 is connected to a terminal on a positive side of the first contact 13a. A negative side bus N of the wireless sensor 21 is connected to a terminal on a negative side of the first contact 13a. The wireless sensor 21 includes a signal detection unit 23, a power acquisition unit 24, and a transmission unit 25.

The signal detection unit 23 is connected to the safety circuit 12 in parallel with the first contact 13a. In other words, the signal detection unit 23 is connected in parallel with the positive side bus P and the negative side bus N as a voltage dividing circuit. The signal detection unit 23 has a signal processing circuit 101, a voltage attenuating resistor 102, and an amplifier 103.

The signal processing circuit 101 is connected to the safety circuit 12 in parallel with the first contact 13a, between the first contact 13a and the power acquisition unit 24 in the positive side bus P and the negative side bus N. The signal processing circuit 101 detects a voltage between terminals of the first contact 13a. For example, the signal processing circuit 101 has a processing circuit such as a high-pass filter that processes a detection result of the voltage. The signal processing circuit 101 outputs an electrical signal indicating the processing result as an analog output. Specifically, for example, the signal processing circuit 101 extracts an AC component or the like that is a specific component included in a chattering waveform in the first contact 13a, and converts and processes the AC component or the like into an electrical signal indicating the specific component and outputs the electrical signal.

The voltage attenuating resistor 102 is connected in series between the first contact 13a and the signal processing circuit 101 as a voltage dividing resistor for a contact voltage. A resistance value of the voltage attenuating resistor 102 is set according to a detection threshold of the safety circuit 12.

The amplifier 103 is connected to the signal processing circuit 101 as a power amplifier. The amplifier 103 amplifies the electrical signal outputted by the signal processing circuit 101. The amplifier 103 inputs the amplified electrical signal to the transmission unit 25 via a contact voltage monitoring line 104.

The power acquisition unit 24 has an acquisition circuit 105. The acquisition circuit 105 is connected in series between the first contact 13a and the transmission unit 25. The acquisition circuit 105 acquires power from the positive side bus P and the negative side bus N and supplies the power to the transmission unit 25.

The acquisition circuit 105 has a diode bridge 106, a constant voltage circuit 107, a non-stable power supply line 108, a stable power supply line 109, a load-side capacitor 110, a storage voltage dividing resistor 111, a storage voltage monitoring line 112, and a constant voltage side capacitor 113.

The diode bridge 106 is connected in series between the first contact 13a and the transmission unit 25. The constant voltage circuit 107 is connected between the diode bridge 106 and the transmission unit 25. The constant voltage circuit 107 converts a voltage from the first contact 13a to a constant voltage value, and supplies it to the transmission unit 25. In other words, the constant voltage circuit 107 stabilizes the voltage of the power supplied to the transmission unit 25. The non-stable power supply line 108 is a conducting wire that constitutes a circuit between the diode bridge 106 and the constant voltage circuit 107. The stable power supply line 109 is a conducting wire constituting a circuit between the constant voltage circuit 107 and the transmission unit 25.

The load-side capacitor 110 is connected in parallel with the constant voltage circuit 107 in the non-stable power supply line 108, as a power storage capacitor. In other words, the load-side capacitor 110 is connected in parallel between the first contact 13a and the transmission unit 25. Electrostatic capacity of the load-side capacitor 110 is set at a value capable of storing a prescribed amount of power. Also, the electrostatic capacity of the load-side capacitor 110 is set at a value exceeding a start voltage of a processing circuit 119 in a prescribed power storage time.

The storage voltage dividing resistor 111 is connected in parallel with the load-side capacitor 110 in the non-stable power supply line 108. A voltage corresponding to the amount of storage power of the load-side capacitor 110 is applied to both ends of the storage voltage dividing resistor 111. The storage voltage monitoring line 112 connects the storage voltage dividing resistor 111 and the transmission unit 25.

The constant voltage side capacitor 113 is connected in parallel with the transmission unit 25 in the stable power supply line 109 as a power storage capacitor.

The power acquisition unit 24 further includes a first high speed charging capacitor 114, a second high speed charging capacitor 115, a first trickle charging resistor 116, and a second trickle charging resistor 117, between the first contact 13a and the acquisition circuit 105, as a capacitor series connection type circuit.

The first high speed charging capacitor 114 is connected in series to the positive side bus P between the first contact 13a and the acquisition circuit 105. The first high speed charging capacitor 114 is a type of capacitor in which a basic failure mode is an open condition. Specifically, for example, the first high speed charging capacitor 114 is an electrolytic capacitor.

Electrostatic capacity of the first high speed charging capacitor 114 is set at a value at which charging is performed at a high speed so that a simulated resistance value becomes a sufficient value in a time shorter than the detection delay time. A characteristic of the resistance value to the amount of storage power of the first high speed charging capacitor 114 is set at a value at which charging is performed at a high speed. For example, the electrostatic capacity of the first high speed charging capacitor 114 is set so that power storage is completed in such a short time that characteristics of the safety circuit 12 are not lost, with respect to the current from the safety circuit 12. A characteristic of the resistance value of the first high speed charging capacitor 114 is the characteristic that shows a low value immediately after the first contact 13a is opened, and shows a high resistance value with an increase in the amount of power storage.

The second high speed charging capacitor 115 is connected in series to the negative side bus N between the first contact 13a and the acquisition circuit 105. A type of the second high speed charging capacitor 115 is of a same type as the first high speed charging capacitor 114. In other words, the first high speed charging capacitor 114 and the second high speed charging capacitor 115 have same characteristics.

The first trickle charging resistor 116 is connected in parallel with the first high speed charging capacitor 114 in the positive side bus P. A resistance value of the first trickle charging resistor 116 is set at a value at which a current bypassing the first trickle charging resistor 116 can be power of the transmission unit 25. The resistance value of the first trickle charging resistor 116 is set at a value at which the power storage capacitor can be trickle charged by the current passing through the first trickle charging resistor 116.

The second trickle charging resistor 117 is connected in parallel with the second high speed charging capacitor 115 in the negative side bus N. A resistance value of the second trickle charging resistor 117 is set at a value at which a current bypassing the second trickle charging resistor 117 can be power of the transmission unit 25. The resistance value of the second trickle charging resistor 117 is set at a value at which the power storage capacitor can be trickle charged by the current bypassing the second trickle charging resistor 117.

The electrostatic capacity of the first high speed charging capacitor 114, the electrostatic capacity of the second high speed charging capacitor 115, the resistance value of the first trickle charging resistor 116, and the resistance value of the second trickle charging resistor 117 are set based on the detection delay time and the detection threshold of the current that are set in the safety circuit 12. As a result of the wireless sensor 21 being connected in parallel with the first contact 13a, a current flows through the wireless sensor 21 even when the first contact 13a is in an open condition, and thereby the safety circuit 12 does not turn to an opened circuit. In order that the detector 15 of the safety circuit 12 can detect opening of the contact 13, the value of the current flowing through the wireless sensor 21 needs to be a value smaller than the detection threshold before the detection delay time elapses after the first contact 13a is opened. Therefore, the electrostatic capacity of the first high speed charging capacitor 114, the electrostatic capacity of the second high speed charging capacitor 115, the resistance value of the first trickle charging resistor 116, and the resistance value of the second trickle charging resistor 117 are determined so that a total value of the currents that flow through the first high speed charging capacitor 114 and the first trickle charging resistor 116 becomes smaller than the detection threshold in a time shorter than a time in which the detection delay time elapses after the first contact 13a is opened.

The transmission unit 25 includes a power reception circuit 118, a processing circuit 119, and a wireless circuit 120.

The power reception circuit 118 is electrically connected to the power acquisition unit 24 as a power reception unit. Specifically, the power reception circuit 118 is connected to the stable power supply line 109 of the acquisition circuit 105. The power reception circuit 118 obtains power from the power acquisition unit 24. The power reception circuit 118 supplies the obtained power to each of the circuits of the transmission unit 25. In other words, the processing circuit 119 and the wireless circuit 120 operate by using the power from the power reception circuit 118.

The processing circuit 119 performs arithmetic operation processing on an electrical signal as an MCU (Micro Controller Unit). The processing circuit 119 creates information to be transmitted as a radio wave based on a result of the arithmetic operation processing. At this time, the processing circuit 119 generally controls an operation performed by the transmission unit 25. The processing circuit 119 includes a ROM 121 (Read Only Memory), a RAM 122 (Random Access Memory), an MCU core 123, a first ADC circuit 124, and a second ADC circuit 125.

The ROM 121 memorizes information such as a program indicating a function implemented by the transmission unit 25. The RAM 122 stores temporary information such as a result of the arithmetic operation processing. The MCU core 123 performs various arithmetic operations as an arithmetic operator. The MCU core 123 executes the program memorized in the ROM 121. The MCU core 123 performs arithmetic operation processing handled by the processing circuit 119 based on the program memorized in the ROM 121, information memorized in the RAM 122, and other information.

The first ADC circuit 124 is an analog-to-digital conversion circuit (Analog-to-Digital Converter). The first ADC circuit 124 is connected to the signal detection unit 23 in the contact voltage monitoring line 104. The first ADC circuit 124 captures input of the electrical signal from the signal detection unit 23. The first ADC circuit 124 converts the electrical signal that is an inputted analog signal into a digital signal.

The second ADC circuit 125 is an analog-to-digital conversion circuit. The second ADC circuit 125 is connected to the storage voltage dividing resistor 111 on the storage voltage monitoring line 112. The second ADC circuit 125 converts an analog electrical signal indicating a resistance value to be applied to the storage voltage dividing resistor 111 into a digital signal.

The wireless circuit 120 is a circuit that converts information created in the processing circuit 119 into a radio wave format. For example, the wireless circuit 120 converts the information into RF (Radio Frequency) waves that are radio frequency waves. The wireless circuit 120 transmits radio waves W from an antenna 126. Further, the wireless circuit 120 may receive radio waves W from the gateway device 22 via the antenna 126. The wireless circuit 120 receives radio waves from the gateway device 22 via the antenna 126.

When the first contact 13a is closed, the current flowing through each of the circuits of the wireless sensor 21 is a value close to zero. When the first contact 13a is opened from the closed condition, the current passing through the safety circuit 12 flows into the first high speed charging capacitor 114 and the second high speed charging capacitor 115. The first high speed charging capacitor 114 and the second high speed charging capacitor 115 are rapidly charged. The first high speed charging capacitor 114 and the second high speed charging capacitor 115 are brought into the condition that exhibits a substantial high resistance value due to rise in the voltage value due to accumulation of electric charges before the detection delay time elapses.

When the first high speed charging capacitor 114 and the second high speed charging capacitor 115 are charged, the load-side capacitor 110 and the constant voltage side capacitor 113 that are power storage capacitors are charged, with the charging. When the voltage value indicated by the power storage capacitor exceeds a prescribed start voltage, the processing circuit 119 that is the MCU starts. For example, the processing circuit 119 captures the electrical signal from the signal detection unit 23 via the first ADC circuit 124. The processing circuit 119 executes various arithmetic operations based on the captured electrical signal. The processing circuit 119 causes the wireless circuit 120 to transmit a radio signal indicating an arithmetic operation result.

When the first contact 13a is open after the processing circuit 119 is started, the current flowing through the safety circuit 12 is supplied to the processing circuit 119 and the power storage capacitor through the first trickle charging resistor 116 and the second trickle charging resistor 117. Therefore, trickle charge is performed for the power storage capacitor. The MCU of the processing circuit 119 can continue a continuous operation. Note that in order to suppress occurrence of false detection in the safety circuit 12, the value of the current flowing in the power acquisition unit 24 in this case is a value below a detection threshold used in the safety circuit 12 as a minimum value in a range in which there is no trouble on the safety system.

When the first contact 13a is closed from the opened condition, a current from the safety circuit 12 does not flow to the power acquisition unit 24. The first high speed charging capacitor 114 and the second high speed charging capacitor 115 start electrical discharge. In this case, since the diode bridge 106 is provided, a combined voltage of the first high speed charging capacitor 114 and the second high speed charging capacitor 115 is applied to the power storage capacitor, and thereby the power storage capacitor is charged. The diode bridge 106 improves power recovery efficiency.

The processing circuit 119 continues the condition of being started by the power stored in the power storage capacitor. The processing circuit 119 monitors the power storage amount of the power storage capacitor based on the signal from the second ADC circuit 125. For example, the processing circuit 119 changes a sampling frequency that is a voltage measurement frequency, according to the power storage amount of the power storage capacitor. In other words, when the power storage amount is smaller than a threshold, the processing circuit 119 decreases the sampling frequency. The processing circuit 119 shifts to an energy saving mode in which the consumption amount of power is small in response to the power storage amount.

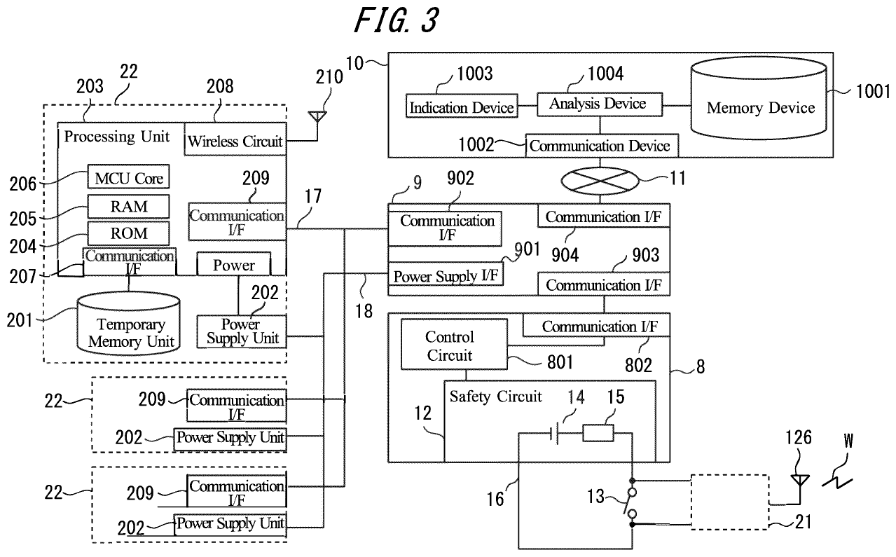

Next, the raising/lowering device information collection system 20 will be described by using FIG. 3.

FIG. 3 is a block diagram of the raising/lowering device information collection system in embodiment 1.

FIG. 3 shows an example in which a plurality of gateway devices 22 are provided in the raising/lowering device information collection system 20. In this case, the wireless sensor 21 communicates with the gateway device 22 of a best communication condition. Each of the plurality of gateway devices 22 includes a similar configuration. The plurality of gateway devices 22 are connected to the remote communication device 9 via a communication line 17 and a power supply line 18.

The gateway device 22 includes a temporary memory unit 201, a power supply unit 202, and a processing unit 203.

The temporary memory unit 201 temporarily memorizes information. The power supply unit 202 is a power circuit. For example, the power supply unit 202 is supplied with power from the remote communication device 9. The power supply unit 202 may be supplied with power from a power supply plug of the building 2. The power supply unit 202 supplies power to each device of the gateway device 22.

The processing unit 203 includes MCU that is a processing circuit. The processing unit 203 includes a ROM 204, a RAM 205, an MCU core 206, a memory unit communication I/F (interface) 207, a wireless circuit 208, and an external communication I/F 209.

The ROM 204, the RAM 205, the MCU core 206, and the wireless circuit 208 include configurations that are respectively similar to the ROM 121, the RAM 122, the MCU core 123 and the wireless circuit 120 not illustrated in FIG. 3 of the wireless sensor 21. The wireless circuit 208 communicates with the wireless sensor 21 by radio waves W via the antenna 210. The memory unit communication I/F 207 causes the temporary memory unit 201 to memorize a processing content of the processing unit 203. The external communication I/F 209 communicates with the remote communication device 9. For example, the external communication I/F 209 transmits information on the processing content of the processing unit 203 to the remote communication device 9.

The processing unit 203 causes the temporary memory unit 201 to memorize information on an electrical signal of the contact 13 as information on the contact, based on the radio waves from the wireless sensor 21. The processing unit 203 transmits the information on the contacts memorized in the temporary memory unit 201 to the remote communication device 9 from the external communication I/F 209 at any timing such as a time when a prescribed cycle passes, and a time when receiving an instruction for transmission from the remote communication device 9.

Note that the processing unit 203 may perform soundness diagnosis such as abnormality judgement on the corresponding contact 13, and failure sign judgement on the contact 13, based on the information received from the wireless sensor 21. In this case, the processing unit 203 may transmit the information indicating a diagnosis result to the remote communication device 9. Further, the processing unit 203 may perform arithmetic operation as preliminary processing for diagnosis, such as integrating the information received from the wireless sensors 21, rearranging the information in a prescribed order, and integrating only information with a specific tendency. In this case, the processing unit 203 may transmit the information after the preliminary processing to the remote communication device 9.

The control device 8 includes the safety circuit 12, a control circuit 801, and a remote communication I/F 802. The control circuit 801 generally controls an operation of the elevator system. The safety circuit 12 has a function of interlock when control of the control circuit 801 is performed. The remote communication I/F 802 is an interface that performs communication with the remote communication device 9.

The remote communication device 9 includes a power supply I/F 901, a GW communication I/F 902, a control device communication I/F 903, and a line network communication I/F 904. The power supply I/F 901 supplies power to each of the plurality of gateway devices 22 via the power supply line 18. The GW (gateway) communication I/F 902 communicates with each of the plurality of gateway devices 22 via the communication line 17. The control device communication I/F 903 communicates with the control device 8. The line network communication I/F 904 communicates with the information center device 10 via the communication line network 11. When the remote communication device 9 receives information from the gateway device 22, the remote communication device 9 transmits the information to the information center device 10. The remote communication device 9 may acquire position information of the car 7 from the control device 8 and transmits the information to the gateway device 22.

The information center device 10 is constituted of a plurality of devices. The information center device 10 includes a memory device 1001, a communication device 1002, an indication device 1003, and an analysis device 1004.

The memory device 1001 memorizes information such as information on the contacts transmitted from the gateway devices 22, and information created by the analysis device 1004. In other words, the memory device 1001 accumulates information measured by the wireless sensors 21. The communication device 1002 communicates with the remote communication device 9 as a communication interface. For example, the indication device 1003 is a display device. The indication device 1003 visually indicates information to a monitoring person of the maintenance company.

The analysis device 1004 performs diagnosis on soundness such as abnormality judgment of the contacts 13 corresponding to the wireless sensors 21, and failure sign judgment of the contacts 13, based on the information received from the gateway device 22. The analysis device 1004 causes the indication device 1003 to indicate the information indicating a result of the diagnosis together with an alert. The analysis device 1004 causes the memory device 1001 to memorize the information indicating the result of the diagnosis.

Note that when the gateway device 22 performs diagnosis, the analysis device 1004 may cause the indication device 1003 to indicate the information indicating a result of the diagnosis performed by the gateway device 22, and cause memory device 1001 to memorize the information.

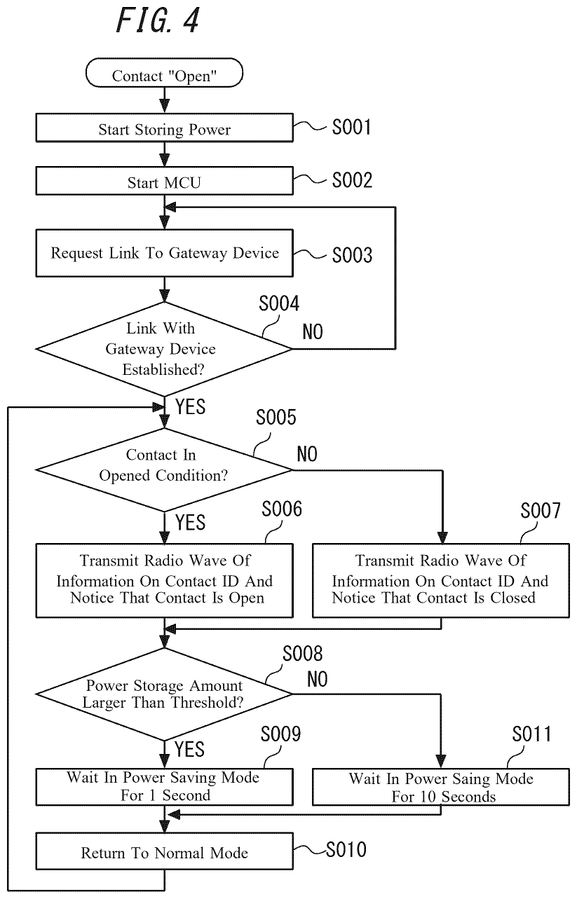

Next, with use of FIG. 4, a first example of a sampling operation performed by the wireless sensor 21 will be described.

FIG. 4 is a flowchart for explaining the first example of the operation of the wireless sensor of the raising/lowering device information collection system in embodiment 1.

In the first example, the wireless sensor 21 measures whether the contact 13 is in an open condition or a closed condition as the condition of the corresponding contact 13, and the voltage of the contact 13 in the closed state. Hereafter, an operation of the wireless sensor 21 corresponding to the first contact 13a will be described.

In FIG. 4, the sampling operation of the flowchart is started when the first contact 13a is opened from the closed condition, that is, when the contact 13 is “open”.

In step S001, in the power storage capacitor of the wireless sensor 21, power storage is started. Further, in the first high speed charging capacitor 114 and the second high speed charging capacitor 115, charging is started.

Thereafter, when prescribed amounts of storage power are stored in the first high speed charging capacitor 114, the second high speed charging capacitor 115, and the power storage capacitor, an operation in step S002 is performed. Specifically, when a voltage value obtained from each of the capacitors exceeds a start voltage value of the MCU, the operation in step S002 is performed. In step S002, the MCU that is the processing circuit 119 is started.

Thereafter, an operation in step S003 is performed. In step S003, the wireless sensor 21 transmits a request to establish link of wireless communication to the gateway device 22.

Thereafter, an operation in step S004 is performed. In step S004, the wireless sensor 21 judges whether or not the link of wireless communication with the gateway device 22 is established. For example, when the wireless sensor 21 receives information of approval of the request for link from the gateway device 22, the wireless sensor 21 judges that the link is established.

When the link is not established in step S004, the operations in step S003 and the following steps are repeated.

When the link is established in step S004, an operation in step S005 is performed. In step S005, the wireless sensor 21 judges whether or not the first contact 13a is in an open state based on the voltage values at both ends of the first contact 13a. In this case, the wireless sensor 21 judges whether the first contact 13a is in the open condition based on the voltage value of the electrical signal detected by the signal detection unit 23.

When the first contact 13a is in an open condition in step S005, an operation in step S006 is performed. In step S006, the wireless sensor 21 creates information in which ID identifying the first contact 13a and a notice that the first contact 13a is open as a detection result of the signal detection unit 23 are associated with each other as information on the condition of the voltage of the contact 13. The wireless sensor 21 transmits a radio wave indicating the created information to the gateway device 22.

When the first contact 13a is not in an open condition in step S005, that is, when the first contact 13a is in a closed condition and short-circuited, an operation in step S007 is performed. In step S007, the wireless sensor 21 creates information in which the ID identifying the first contact 13a and the notice that the first contact 13a is closed as the detection result of the signal detection unit 23 are associated with each other as information on the condition of the voltage of the contact 13. At this time, the wireless sensor 21 may further associate information indicating the measured voltage value of the first contact 13a. The wireless sensor 21 transmits a radio wave indicating the created information to the gateway device 22.

After the operation in step S006 or step S007 is performed, an operation in step S008 is performed. In step S008, the wireless sensor 21 judges whether or not the power storage amount is greater than a prescribed power storage threshold. In other words, the wireless sensor 21 judges whether or not an amount of remaining storage power is great.

When the power storage amount is greater than the prescribed power storage threshold in step S008, an operation in step S009 is performed. In step S009, the wireless sensor 21 waits in an energy saving mode for one second as a short sampling cycle. The energy saving mode is a mode in which energy consumption is less than in a normal mode. Note that the short sampling cycle may be set at any time period according to conditions such as conditions of the condition of the contact 13, and the conditions of the power storage amount of the wireless sensor 21. For example, the shorter the sampling cycle, the more the number of times the detection result of the voltage of the contact 13 is sampled. The more the number of sampling times, the more the amount of the stored power increases.

Thereafter, an operation in step S010 is performed. In step S010, the wireless sensor 21 returns from the energy saving mode to the normal mode. Thereafter, the operations in step S005 and the following steps are repeated.

When the power storage amount is smaller than the prescribed power storage threshold in step S008, an operation in step S011 is performed. In step S011, the wireless sensor 21 waits in the energy saving mode for 10 seconds as a long sampling cycle. Note that the long sampling cycle can be set at any time period according to conditions such as the conditions of the conditions of the contact 13, and the condition of the power storage amount of the wireless sensor 21, if only the time period is longer than the short sampling cycle.

Thereafter, the operations in S010 and the following steps are performed.

The wireless sensor 21 continues the sampling operation until the storage power voltage corresponding to the power storage amount falls below a prescribed value. When the storage power voltage falls below the prescribed value, the wireless sensor 21 transmits information in which the ID of the corresponding contact 13 and the notice of shift to the energy saving mode are associated, to the gateway device 22. Note that the wireless sensor 21 may shift to the energy saving mode when a prescribed time elapses after it detects that the first contact 13a is closed.

Note that when the first contact 13a is opened from the closed condition in the condition in which the power storage amount of the wireless sensor 21 is depleted, the wireless sensor 21 cannot measure a change in the voltage of the first contact 13a as a result of opening. However, after the sampling operation, if the power storage amount that is equal to or greater than an operable amount remains, and the wireless sensor 21 does not shift to the energy saving mode, the wireless sensor 21 can also measure the change in the voltage of the first contact 13a as the result of the opening.

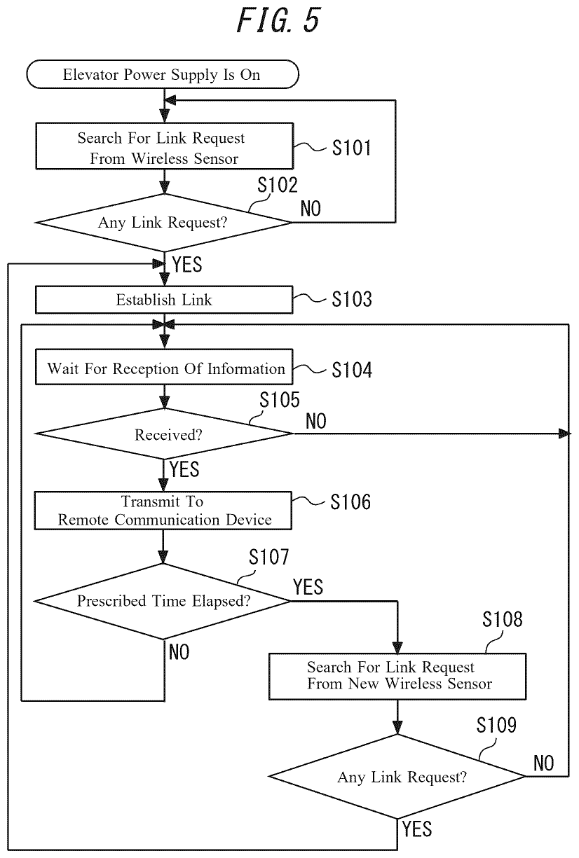

Next, a first example of an operation performed by the gateway device 22 will be described by using FIG. 5.

FIG. 5 is a flowchart for explaining the first example of the operation of the gateway device of the raising/lowering device information collection system in embodiment 1.

In the first example, the gateway device 22 performs an operation corresponding to the operation of the first example of the wireless sensor 21.

As shown in FIG. 5, the gateway device 22 starts the operation of the flowchart when the power supply of the elevator system is turned on.

In step S101, the gateway device 22 searches for a request for link from the wireless sensor 21.

Thereafter, an operation in step S102 is performed. In step S102, the gateway device 22 judges whether or not there is a request for link from the wireless sensor 21.

When there is no request for link from the wireless sensor 21 in step S102, the gateway device 22 repeats the operations of step S101 and the following step.

When there is a request for link from the wireless sensor 21 in step S102, an operation in step S103 is performed. In step S103, the gateway device 22 establishes link with the wireless sensor 21 that has the request for link. The gateway device 22 starts a timer from a time 0.

Thereafter, an operation in step S104 is performed. In step S104, the gateway device 22 is brought into a condition of waiting for reception of information about the condition of the contact 13 from the wireless sensor 21.

Thereafter, an operation in step S105 is performed. In step S105, the gateway device 22 judges whether or not it receives the information about the condition of the contact 13 from the wireless sensor 21.

When the gateway device 22 does not receive the information about the condition of the voltage of the contact 13 in step S105, the operations in step S104 and the following step are repeated.

When the gateway device 22 receives the information about the condition of the contact 13 in step S105, an operation in step S106 is performed. In step S106, the gateway device 22 transmits the information about the condition of the voltage of the contact 13 that is received to the remote communication device 9 as the information about the contact.

Thereafter, an operation in step S107 is performed. In step S107, the gateway device 22 judges whether the time of the timer has a value equal to or longer than a prescribed time. That is to say, the gateway device 22 judges whether or not the prescribed time elapses after establishing the link with the wireless sensor 21.

When the time of the timer is shorter than the prescribed time in step S107, the operations in step S104 and the following steps are performed.

When the time of the timer is equal to or longer than the prescribed time in step S107, an operation in step S108 is performed. In step S108, the gateway device 22 searches for a request for link from the new wireless sensor 21 other than the wireless sensor 21 currently establishing the link.

Thereafter, an operation in step S109 is performed. In step S109, the gateway device 22 judges whether or not there is a request for link from the new wireless sensor 21.

When there is the request for link from the new wireless sensor 21 in step S109, the gateway device 22 performs the operation of step S103 and the following steps.

When there is no request for link from the new wireless sensor 21 in step S109, the gateway device 22 repeats the operations in step S104 and the following steps.

Note that when there is not request for link from the new wireless sensor 21 in step S109, the gateway device 22 may perform the operations in step S108 and the following steps.

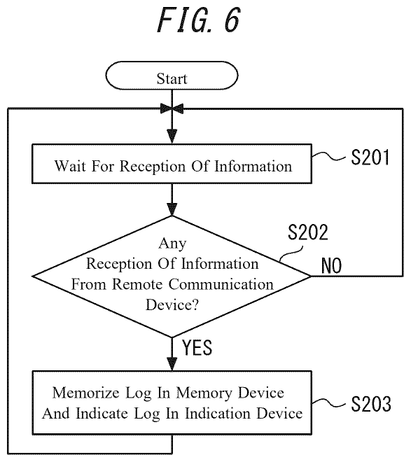

Next, a first example of an operation performed by the information center device 10 be described by using FIG. 6.

FIG. 6 is a flowchart for explaining the first example of the operation of the raising/lowering device information collection system in embodiment 1.

In the first example, the information center device 10 performs an operation corresponding to the operations of the first examples of the wireless sensor 21 and the gateway device 22. For example, the information center device 10 starts an operation of the flowchart when the remote communication device 9 is started.

As shown in FIG. 6, in step S201, the information center device 10 waits to receive information on a measurement result of the wireless sensor 21 from the remote communication device 9.

Thereafter, the operation in step S202 is performed. In step S202, the information center device 10 judges whether or not there is reception of information from the remote communication device 9.

When there is no reception of the information from the remote communication device 9 in step S202, the operations in step S201 and the following steps are repeated.

When there is reception of the information from the remote communication device 9 in step S202, an operation in step S203 is performed. In step S203, the analysis device 1004 of the information center device 10 causes the memory device 1001 to memorize a log to the effect that the information is received from the remote communication device 9 and the information. The analysis device 1004 causes the indication device 1003 to indicate the log to the effect that the information is received from the remote communication device 9 and the information.

Thereafter, the information center device 10 repeats the operations in step S201 and the following steps.

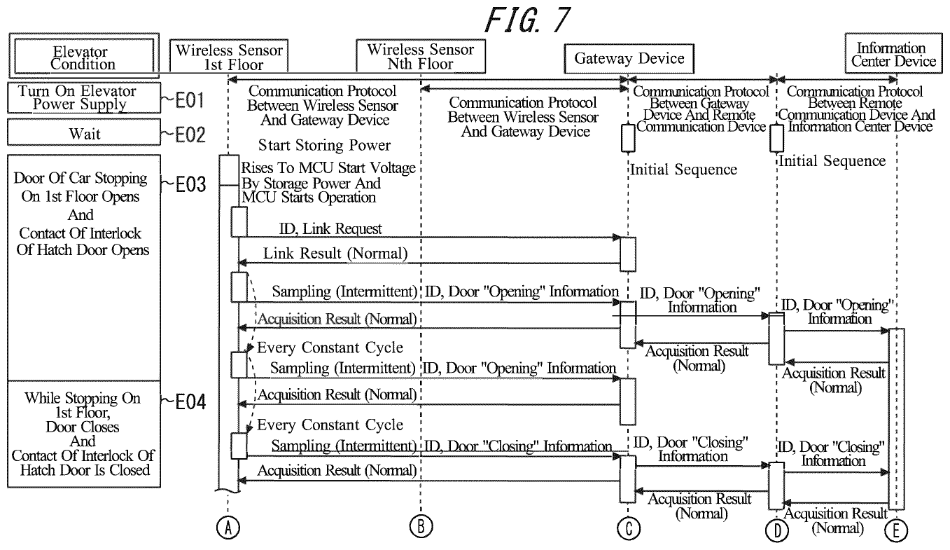

Next, with use of FIG. 7 to FIG. 9, a first example of a series of operations performed by the raising/lowering device information collection system 20 will be described.

FIG. 7 to FIG. 9 are sequence diagrams for explaining the first example of the raising/lowering device information collection system in embodiment 1.

In FIG. 7, operations performed by the “wireless sensor first floor”, the “wireless sensor N^{th} floor”, the “gateway device”, the “remote communication device”, and the “information center device” with respect to the “condition of the elevator” are shown in time series. The “condition of the elevator” is “the condition of the elevator system”. As the “condition of the elevator”, a condition E01 to a condition E09 are shown. The “wireless sensor first floor” shows an operation of the wireless sensor 21 provided at the hatch door 5 on a first floor. The “wireless sensor N^{th} floor” shows an operation of the wireless sensor 21 provided at the hatch door 5 on an N^{th} floor that is not the first floor.

The wireless sensor 21 and the gateway device 22 perform communication based on a dedicated communication protocol. The remote communication device 9 performs communication with the gateway device 22 and the information center device 10 based on respective dedicated communication protocols.

In the condition E01, the power supply of the elevator system is turned on. The gateway device 22 and the remote communication device 9 are started.

In a condition E02, the elevator system waits until a call for the car 7 is made. The gateway device 22 and the remote communication device 9 are brought into a waiting condition through an initial sequence after start.

In a condition E03, after the car 7 stops on the first floor, the car door 7a opens the contact 13 of the interlock provided at the hatch door 5 on the first floor. The wireless sensor 21 on the first floor starts charging each of the capacitors. After the voltage value of the power storage capacitor exceeds the start voltage of the MCU, the transmission unit 25 of the wireless sensor 21 on the first floor starts operation. The wireless sensor 21 on the first floor requests link to the gateway device 22. The wireless sensor 21 on the first floor intermittently performs a sampling operation after the result of the link is normal and the link is established. In other words, when the hatch door 5 on the first floor is open, the wireless sensor 21 on the first floor transmits a result of sampling that the hatch door 5 is in the open condition to the gateway device 22. At this time, the wireless sensor 21 on the first floor may transmit information on the sampled voltage value together. When receiving the information from the wireless sensor 21 on the first floor, the gateway device 22 transmits a radio wave indicating that it normally acquires the information to the wireless sensor 21 on the first floor. The gateway device 22 transmits the information indicating the result to the remote communication device 9. The remote communication device 9 transmits the received information to the information center device 10. The information center device 10 accumulates the information.

In a condition E04, the car door 7a and the hatch door 5 on the first floor are closed. The contact 13 of the interlock provided at the hatch door 5 on the first floor is closed. The wireless sensor 21 on the first floor detects that the contact 13 is closed by the sampling operation performed after the contact 13 on the first floor is closed. The wireless sensor 21 on the first floor transmits the information on the condition of the voltage of the contact 13 to the gateway device 22. The gateway device 22 transmits the information to the information center device 10 via the remote communication device 9. The information center device 10 accumulates the information. The information center device 10 may indicate the information to the monitoring person.

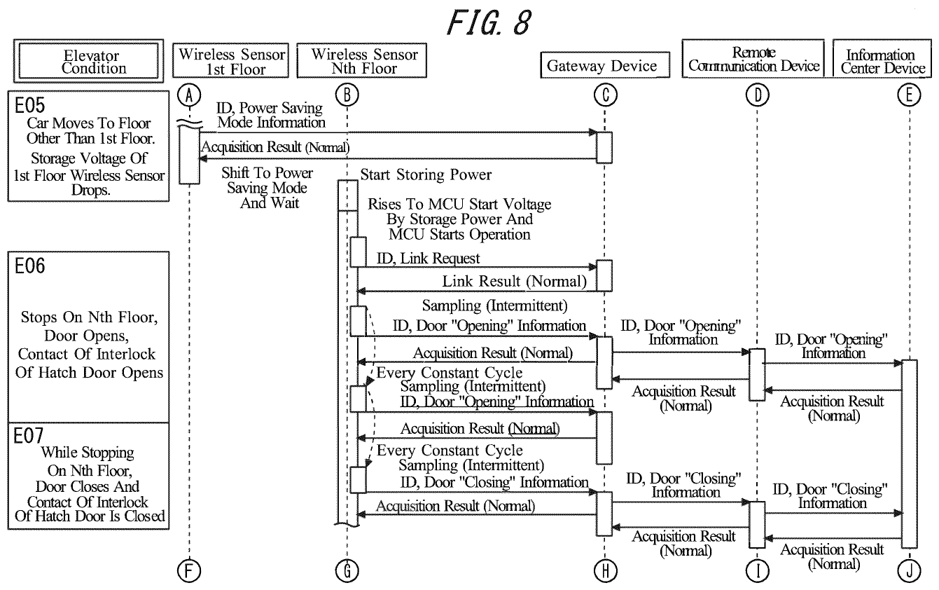

As shown in FIG. 8, in a condition E05, the car 7 moves to a floor other than the first floor. The storage power amount of the wireless sensor 21 on the first floor gradually decreases. When the storage voltage value corresponding to the storage power amount falls below a prescribed value, the wireless sensor 21 on the first floor transmits information in which ID of the corresponding contact 13 and the notice that it shifts to the energy saving mode are associated with each other to the gateway device 22. When receiving the notice that the acquisition result of the information is normal from the gateway device 22, the wireless sensor 21 on the first floor shifts to the energy saving mode, and waits.

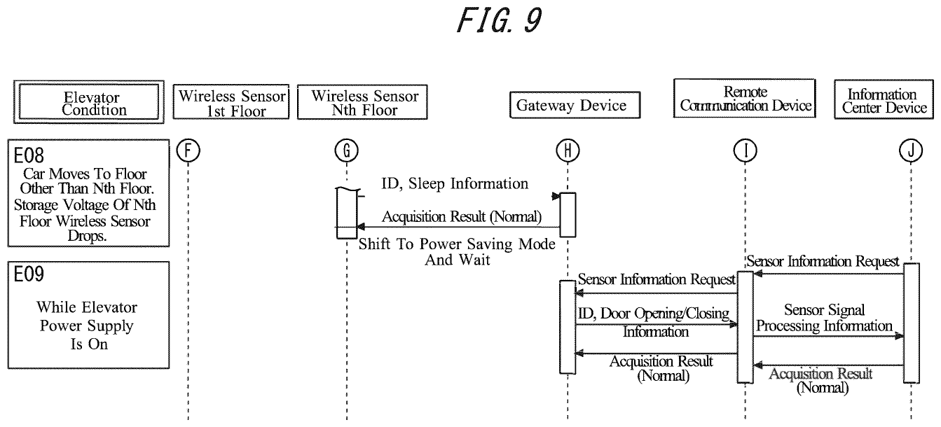

As shown in FIG. 8 and FIG. 9, from a condition E06 to a condition E08, the wireless sensor 21 on the Nth floor where the car 7 stops, performs a similar operation to the operation of the wireless sensor 21 on the first floor in the condition E03 to the condition E05. At this time, the gateway device 22, the remote communication device 9, and the information center device 10 perform similar operations.

Note that in the condition E09, an operation performed when there is a query from the information center device 10 in the condition in which the power supply of the elevator system is turned on, is shown. The information center device 10 transmits an instruction to request information about the wireless sensor 21 to the gateway device 22 via the remote communication device 9 at any timing. The gateway device 22 transmits information in which the ID and the opening and closing condition of the contact 13 to which the wireless sensor 21 currently establishing link corresponds are associated with each other to the information center device 10 as the sensor signal processing data. At this time, the gateway device 22 may transmit the result of processing the information from the wireless sensor 21 together.

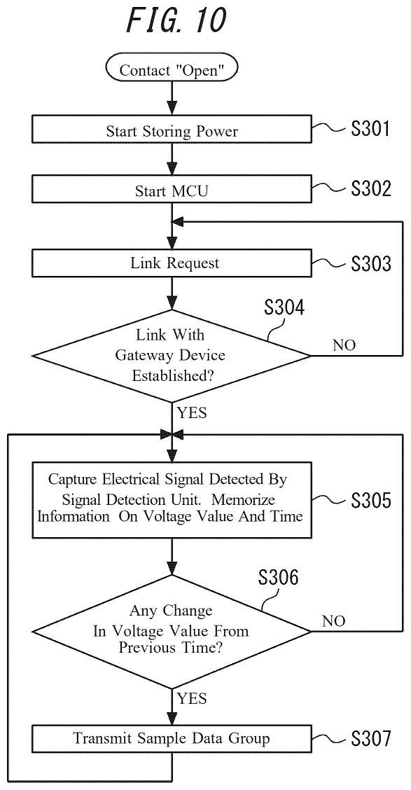

Next, by using FIG. 10, a second example of the sampling operation performed by the wireless sensor 21 will be described.

FIG. 10 is a flowchart for explaining a second example of the operation of the wireless sensor of the raising/lowering device information collection system in embodiment 1.

In the second example, the wireless sensor 21 mainly measures a waveform of chattering of the contact 13 as the condition of the corresponding contact 13.

Chattering is a phenomenon in which a voltage value vibrates due to a bounce, sliding or the like of a contactor when the contact is closed from the open condition. Chattering can occur at any contact. Due to effects such as an effect of an environment in which the contacts are installed, an effect of arc discharge at a time of opening and closing, deterioration such as oxidation, corrosion, shape changes progresses on surfaces of the contacts. When deterioration of the contact progresses, specific change tends to occur in the waveform of chattering, such as a transition duration of the generated chattering, the number of times of change of the voltage. Therefore, diagnosis of the deterioration condition of the contact can be performed based on the waveform of chattering that is the waveform of the voltage value immediately after closing.

The wireless sensor 21 measures a transient change of the voltage when the corresponding contact 13 changes from the open condition to the closed condition. Hereinafter, the operation of the wireless sensor 21 corresponding to the first contact 13a will be described.

In FIG. 10, a sampling operation of the flowchart is started when the first contact 13a is “open”.

Operations that are performed in step S301 to step S304 are the same as the operations performed in step S001 to step S004 in the flowchart in FIG. 4.

After step S304, an operation in step S305 is performed. In step S305, the processing circuit 119 of the wireless sensor 21 captures an electrical signal detected by the signal detection unit 23 via the first ADC circuit 124. The electrical signal shows a voltage value in the open condition or the closed condition of the first contact 13a. The processing circuit 119 memorizes information in which a captured time and a captured voltage value are associated with each other.

Thereafter, an operation in step S306 is performed. In step S306, the processing circuit 119 judges whether or not there is a change in the currently captured voltage value and a voltage value captured at a previous time. At this time, the processing circuit 119 judges that there is a change in the two voltage values when an absolute value of a difference between the two voltage values exceeds a prescribed threshold.

When it is judged that there is no change in the voltage values in step S306, the operations in step S305 and the following step are performed.

When it is judged that there is a change in the voltage values in step S306, an operation in step S307 is performed. In step S307, the processing circuit 119 transmits information on a sample data group in which the ID of the first contact 13a, a time in a time period before and after opening and closing including the currently captured time are associated to the gateway device 22. The sample data group shows transitional change of the voltage value, that is, the change in the voltage value until the time immediately after the first contact 13a is closed from the time immediately before the first contact 13a is closed from the open condition.

Thereafter, the wireless sensor 21 performs the operations in step S305 and the following steps.

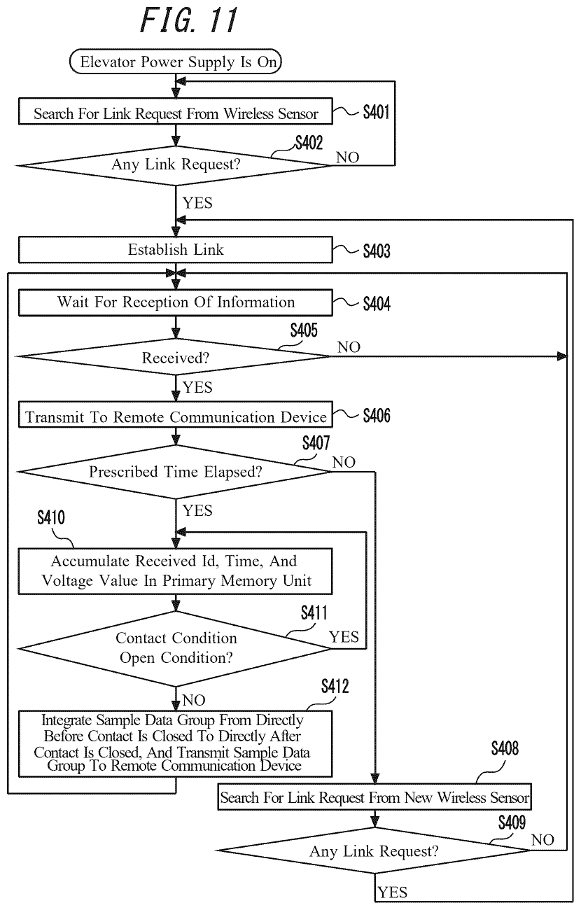

Next, by using FIG. 11, a second example of the operation performed by the gateway device 22 will be described.

FIG. 11 is a flowchart for explaining the second example of the operation of the gateway device of the raising/lowering device information collection system in embodiment 1.

In the second example, the gateway device 22 performs an operation corresponding to the operation of the second example of the wireless sensor 21.

As shown in FIG. 11, the gateway device 22 starts the operations in the flowchart when the elevator system is turned on.

Operations that are performed in step S401 to step S407 are the same as the operations performed in step S101 to step S107 in the flowchart in FIG. 5. However, in the flowchart in FIG. 11, information from the wireless sensor 21 is information on a sample data group in which the ID of the contact 13, the time, and the voltage value are associated.

When the time of the timer is equal to or longer than a prescribed time in step S407, operations in step S408 and following steps are performed. Operations performed in step S408 to step S409 are the same as the operations performed in step S108 to step S109 in the flowchart in FIG. 5.

When the time of the timer is shorter than the prescribed time in step S407, an operation in step S410 is performed. In step S410, the gateway device 22 receives information from the wireless sensor 21 one time or more. When receiving the information, the gateway device 22 accumulates the information in which the ID, the time and the voltage value are associated, which is received from the wireless sensor 21, in the temporary memory unit 201.

Thereafter, an operation in step S411 is performed. In step S411, the gateway device 22 judges whether or not the condition of the contact 13 indicated in the latest information from the wireless sensor 21 is the open condition.

When the latest condition of the contact 13 is the open condition in step S411, the operations in step S410 and the following steps are repeated.

When the latest condition of the contact 13 is the closed condition, that is, when the contact 13 is closed from the open state in step S411, an operation in step S412 is performed. In step S412, the gateway device 22 integrates information of the sample data group based on the information memorized in the temporary memory unit 201. Note that at this time, the gateway device 22 may integrate the sample data group constituted of any number of samples including the information on the voltage value immediately after closing. The gateway device 22 may integrate the sample data group constituted of any time width including the time immediately after closing. The gateway device 22 transmits the information on the integrated sample data group to the remote communication device 9 as the information on the contacts.

Thereafter, the gateway device 22 repeats the operations in step S404 and the following steps.

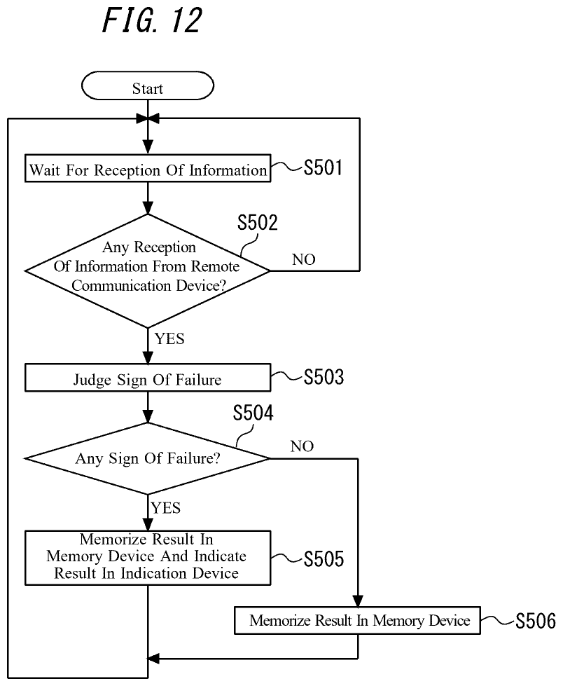

Next, a second example of the operation performed by the information center device 10 will be described by using FIG. 12.

FIG. 12 is a flowchart for explaining a second example of the operation of the information center device of the raising/lowering device information collection system in embodiment 1.

In the second example, the information center device 10 performs an operation corresponding to the operation of the second example of the wireless sensor 21 and the gateway device 22. For example, the information center device 10 performs judgment of a sign of a failure of the contact 13 based on the received information.

Operations that are performed in step S501 to step 502 in the flowchart in FIG. 12 are the same as the operations performed in step S201 to step S202 in the flowchart in FIG. 6.

When there is reception of information on the contact from the remote communication device 9 in step S502, an operation in step S503 is performed. In step S503, the analysis device 1004 of the information center device 10 performs judgment of a sign of a failure of the contact 13 based on the received information. Specifically, the analysis device 1004 analyzes a transient change of the voltage value measured at the contact 13. In the sign judgment, analysis such as whether an abnormal waveform exists in the transient change is performed. Specifically, analysis is performed such as comparing the amount of change in the voltage value, such as the transition duration of the contact voltage value, and the number of times the contact voltage value changes, with an amount of change in the voltage value serving as a standard. For example, as the amount of change in the voltage value serving as the standard, a similar amount of change in a contact in an unused condition is used. At this time, life estimation of the contact 13 may be performed.

Thereafter, an operation in step S504 is performed. In step S504, the analysis device 1004 judges whether or not there is a sign of a failure in the contact 13 based on a result of the diagnosis.

When it is judged that there is a sign of a failure in step S504, an operation in step S505 is performed. In step S505, the analysis device 1004 causes the indication device 1003 to indicate a result of the judgement with an alert. The analysis device 1004 causes the memory device 1001 to memorize the result of the judgement. Thereafter, the operations in step S501 and the following steps are performed.

When it is judged that there is no sign of a failure in step S504, an operation in step S506 is performed. In step S506, the analysis device 1004 causes the memory device 1001 to memorize the result of the judgement. Thereafter, the operations in step S501 and the following steps are performed.

Note that in step S503 to step S504, the information center device 10 may perform diagnosis of soundness instead of sign judgement of a failure. In this case, the information center device 10 also memorizes a diagnosis result, and informs the monitoring person when there is abnormality.

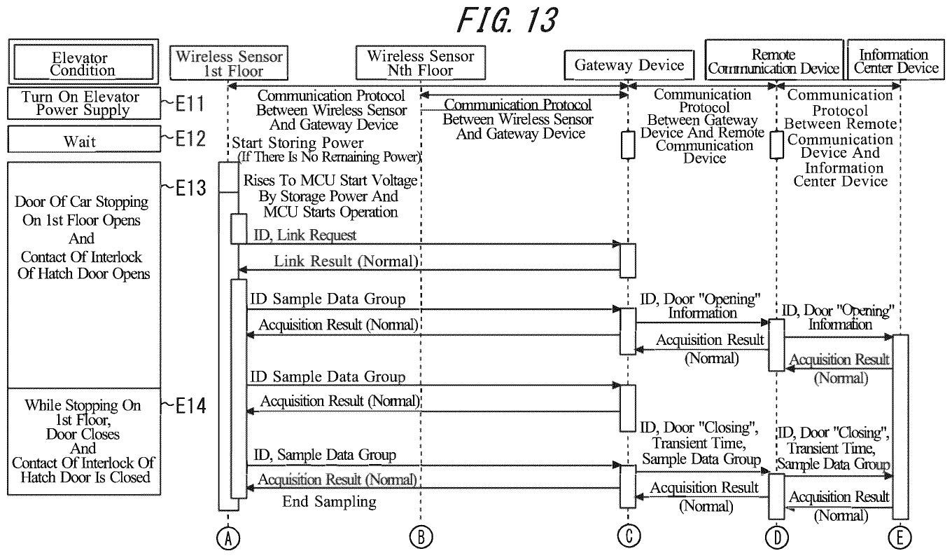

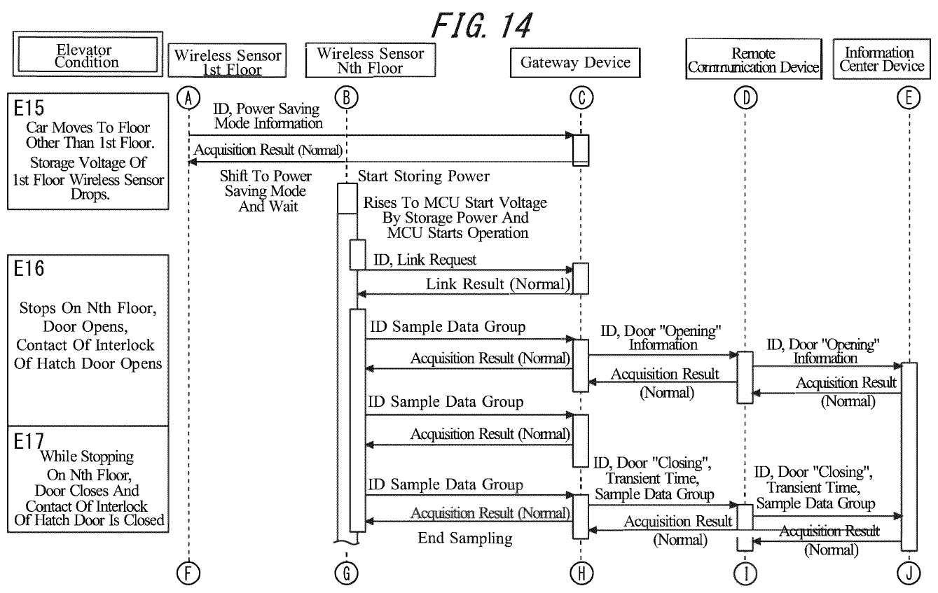

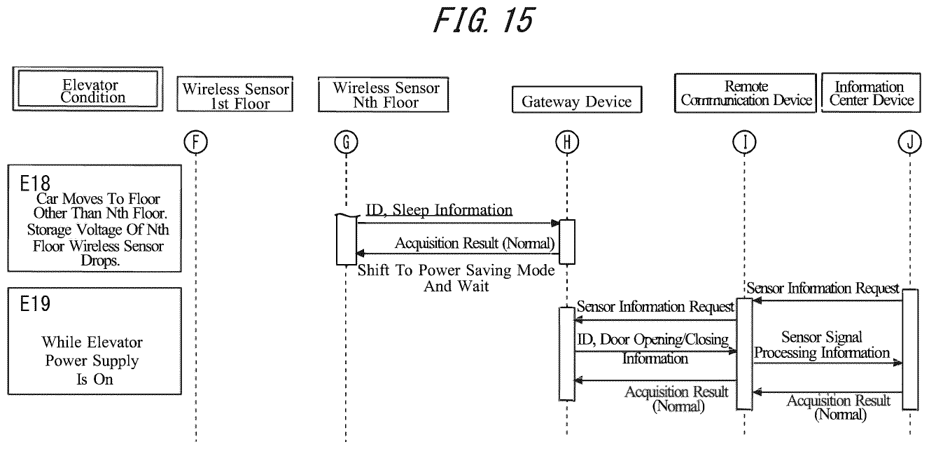

Next, a second example of the series of operations performed by the raising/lowering device information collection system 20 will be described by using FIG. 13 to FIG. 15.

FIG. 13 to FIG. 15 are sequence diagrams for explaining the second example of the operation of the raising/lowering device information collection system in embodiment 1.

Operations that are performed in a condition E11 to a condition E19 in the sequence diagrams of the second example shown in FIG. 13 to FIG. 15 are the same except for some of the operations as compared with the operations performed in the condition E01 to the condition E09 in the sequence diagrams of the first example shown in FIG. 7 to FIG. 9.

Specifically, in the condition E13 and the condition E14, the wireless sensor 21 transmits information in which a time, a voltage value and ID are associated, which serves as a basis of the sample data group, to the gateway device 22. When the contact 13 is brought into a closed condition, the gateway device 22 transmits the information on the sample data group to the information center device 10 as the information of the contacts. These operations are different from those in the condition E03 and the condition E04.

Further, in a condition E16 and a condition E17, the similar operations are different from those in the condition E06 and the condition E07.

According to embodiment 1 described above, the raising/lowering device information collection system 20 incudes the wireless sensor 21 and the gateway device 22. The wireless sensor 21 includes the signal detection unit 23 and the power acquisition unit 24, and the transmission unit 25. The transmission unit 25 operates by the power acquired by the power acquisition unit 24 and transmits radio waves. In other words, the wireless sensor 21 transmits radio waves indicating the condition of the voltage of the contact by using the power obtained from the safety circuit. Therefore, the wireless sensor 21 can transmits the conditions of the plurality of contacts 13 individually to outside. Further, there is no need to provide the wiring for supplying power to the wireless sensor 21, and wiring for transmitting the detection result of the wireless sensor 21. As a result, the wireless sensor 21 can suppress an increase in the amount of wiring. Material cost of the wiring material, material cost of the circuit receiving the wiring, processing cost, and the like can be reduced, and construction labor of the wiring can be reduced. Replacement work of a battery or the like for operating the sensor can be reduced.

Furthermore, for example, in the elevator system described in the prior art literature, in the cases such as the case in which the amount of movement of the auxiliary contact is small, in the case in which bad contact occurs due to contact roughening, and in the case in which the contact is fixed, the result of detection of opening of the auxiliary contact may not coincide with the opening conditions of the contacts of the safety circuit. When a plurality of contacts of the safety circuit open, a false detection can occur. When the number of contacts to be detected is large, it is necessary to prepare resistors having many kinds of resistance values, and reduction in productivity is caused. In addition, it is necessary to replace the contacts of the safety circuit, and retrofitting to the existing raising/lowering device is not easy. The wireless sensor 21 of the present disclosure can detect the conditions of the contacts 13 individually. Therefore, the conditions of the contacts of the safety circuit can be accurately detected. As a result, the time for identifying the bad contact spot of the contact 13 can be reduced, and efficiency of the maintenance work can be improved.

Further, the wireless sensor 21 has the acquisition circuit 105. Since the wireless sensor 21 can be attached by being connected to both the terminals, that is, can be easily attached, to the existing contact, the wireless sensor 21 can be easily retrofitted to the existing raising/lowering device.

Further, the wireless sensor 21 has the first high speed charging capacitor 114. The first high speed charging capacitor 114 is connected in series between the first contact 13a and the acquisition circuit 105. The first high speed charging capacitor 114 is less likely to cause a short-circuit failure. Therefore, even when a failure occurs to the first high speed charging capacitor 114, the failure is an open failure, and an adverse effect on the reliability of the safety circuit 12 can be suppressed.

Further, the first high speed charging capacitor 114 stores power to indicate a high resistance value in a pseudo manner in a time shorter than a detection delay time. The pseudo resistance value is a resistance value expressing that the output voltage of the capacitor rises due to power storage, and it becomes difficult for a current to flow into the capacitor with respect to the applied voltage. Therefore, after a constant power is acquired from the safety circuit 12, the current from the safety circuit 12 can be prevented from flowing in.

Further, the wireless sensor 21 has the first trickle charging resistor 116. Therefore, even after power storage of the first high speed charging capacitor 114 is completed, supply of the power can be received from the safety circuit 12.

Further, in the wireless sensor 21, the current value of the current flowing through the first high speed charging capacitor 114 and the current flowing through the first trickle charging resistor 116 is designed to be a value smaller than the detection threshold in a time shorter than the detection delay time. Therefore, it is possible to suppress an adverse effect on the detection of the contact 13 of the safety circuit 12 due to installation of the wireless sensor 21.

Further, the wireless sensor 21 has the second high speed charging capacitor 115. Therefore, even if a short-circuit failure occurs to the first high speed charging capacitor 114 in the case of emergency, the second high speed charging capacitor 115 makes it difficult for the current from the safety circuit 12 to flow in. As a result, an adverse effect on the reliability of the safety circuit 12 can be suppressed. Moreover, even if a short-circuit failure occurs in both the first high speed charging capacitor 114 and the second high speed charging capacitor 115, there is a load-side resistance to the contact 13, and therefore, the possibility of failure in the low resistance condition is extremely low.

Further, the wireless sensor 21 has the power storage capacitor. Therefore, even after the first contact 13a is closed, the wireless sensor 21 can be driven by the power of the power storage capacitor. Further, the power storage capacitor can be trickle-charged by the power from the first trickle charging resistor 116.

Further, the wireless sensor 21 detects whether the first contact 13a is in an open condition or a closed condition, as the condition of the first contact 13a. Therefore, it is possible to detect which contact 13 of the plurality of contacts 13 is open.

Further, the wireless sensor 21 detects a change in the voltage value at a time when the first contact 13a is closed from an open condition, as the condition of the first contact 13a. Therefore, the wireless sensor 21 can detect the waveform of chattering that occurs in the first contact 13a.

The signal detection unit 23 of the wireless sensor 21 includes the signal processing circuit 101, the voltage attenuating resistor 102, and the amplifier 103. Therefore, the wireless sensor 21 can detect the voltages at both ends of the first contact 13a in an analog manner with high resolution.

Further, the raising/lowering device information collection system 20 further includes the information center device 10. The information center device 10 diagnoses soundness of the first contact 13a based on the information detected by the wireless sensor 21, and received via the gateway device 22. Therefore, failures due to the conditions of the contact such as oxidation, and roughening of the contact surface can be detected early. Further, based on the diagnosis result, the life of the first contact 13a can be estimated, and reflected in a maintenance plan.

Note that the gateway device 22 may diagnose soundness of the first contact 13a based on the information indicated by the radio signal from the wireless sensor 21. Therefore, a failure due to the condition of the contact, such as oxidation, and roughening of the contact surface can be detected early.

Note that the wireless sensor 21 may be supplementarily provided with auxiliary batteries such as a primary battery, and a secondary battery. For example, in the second example of the operation of the wireless sensor 21, the power consumption is greater than in the first example. The wireless sensor 21 can operate more safely by using power of the auxiliary battery in combination. In this case, the number of replacement times of the auxiliary battery can also be reduced by acquiring the power from the safety circuit 12.

Note that the safety circuit 12 is also applied to interlock other than the interlock of the plurality of hatch doors 5. Specifically, the safety circuit 12 is also applied to detection of the position detection switch and the limit switch of the car 7. The safety circuit 12 is also applied to a device provided in the car 7. The wireless sensor 21 and the raising/lowering device information collection system 20 can also be applied to the contacts provided at these safety circuits 12.

For example, when the wireless sensor 21 is provided in the car 7, a plurality of gateway devices 22 may be provided inside the hoistway 1. In this case, the wireless sensor 21 may change the gateway device 22 to which it is connected and establish link with another gateway device 22 again according to a connection condition of wireless communication that changes depending on the position of the car 7.

Note that the raising/lowering device information collection system 20 may be applied to a raising/lowering device other than that of the elevator system. In this case, the wireless sensor 21 is attached to a contact constituting a safety circuit of the raising/lowering device.

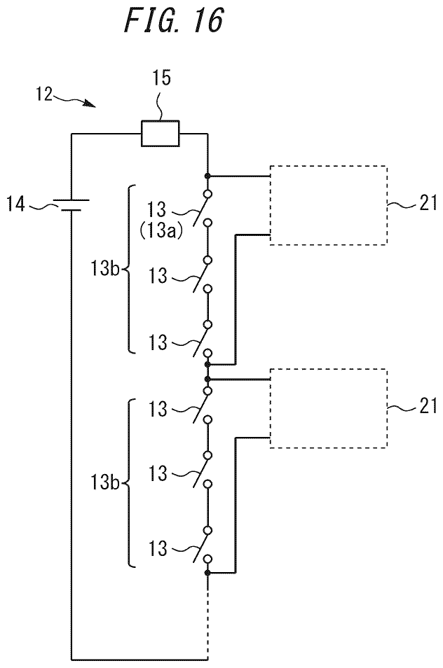

Next, a first modification of embodiment 1 will be described by using FIG. 16.

FIG. 16 is a view showing a relationship between a wireless sensor and a contact of a raising/lowering device information collection system in the first modification of embodiment 1.

As shown in FIG. 16, in the first modification, a wireless sensor 21 is connected to both ends of a contact group 13b. The contact group 13b is a group in which a plurality of contacts 13 are connected in series. The contact group 13b may include the first contact 13a in embodiment 1. The wireless sensor 21 is connected to a terminal on a positive side in a contact 13 on a most positive side included in the contact group 13b, and a terminal on a negative side in a contact 13 on a most negative side included in the contact group 13b.

The wireless sensor 21 memorizes an ID identifying the contact group 13b. When any of the contacts 13 included in the contact group 13b opens, the wireless sensor 21 can perform an operation similar to that in embodiment 1. In this case, the wireless sensor 21 can transmit a radio signal indicating a condition of any of the contacts 13 included in the contact group 13b. Therefore, an area in which the contact 13 opens can be identified.

Though not illustrated, a gateway device 22 acquires position information of a car 7 from a control device 8. When receiving a radio signal indicating that the contact 13 included in the contact group 13b is opened, the gateway device 22 determines which contact 13 the opened contact 13 indicated by the radio signal is, based on the position information of the car 7. Specifically, for example, when the wireless sensor 21 corresponds to the contact group 13b including the contact 13 provided at a hatch door 5 on the second floor, the gateway device 22 identifies the contact 13 provided on the second floor as the opened contact indicated by the radio wave from the wireless sensor 21 based on the position information that the car 7 is present on the second floor.

According to the first modification of embodiment 1 described above, the wireless sensor 21 is connected to both the ends of the contact group 13b. Therefore, as compared with embodiment 1, the number of wireless sensors 21 can be reduced.

Further, the gateway device 22 identifies the opened contact 13 from the contact group 13b based on the position information of the car 7. Therefore, the opened contact 13 can be identified in the configuration of the first modification.

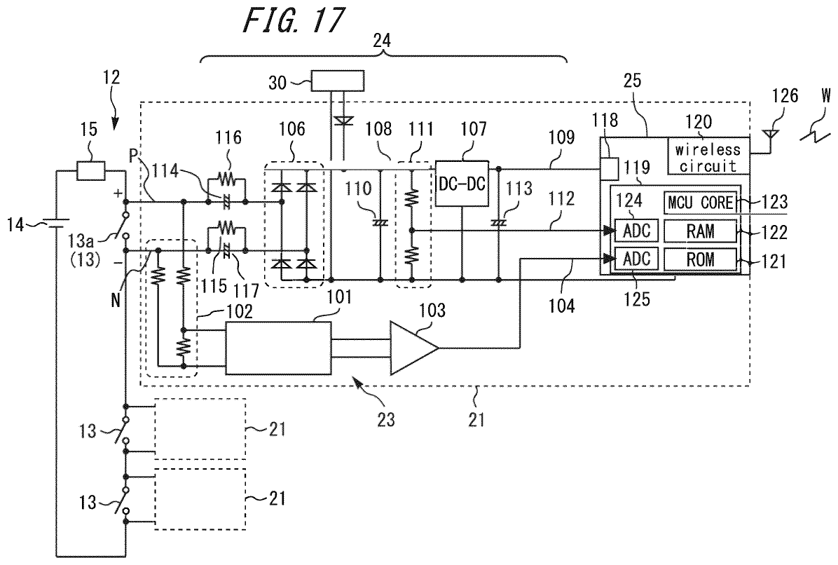

Next, a second modification of embodiment 1 will be described by using FIG. 17.

FIG. 17 is a schematic diagram showing a configuration of a wireless sensor of a raising/lowering device information collection system in the second modification of embodiment 1.

As shown in FIG. 17, in the second modification, an external power generation device 30 can be connected to a wireless sensor 21.

The external power generation device 30 is a device capable of generating electric power. For example, the external power generation device 30 is a power generation device to which energy harvesting technology that can perform emergency power generation in an installed environment is applied. Specifically, the external power generation device 30 is a power generation device that converts energy such as light energy, wind energy, vibration energy, or energy existing due to a temperature difference in the installation environment into electric power energy. The external power generation device 30 supplies generated power to the wireless sensor 21.

The wireless sensor 21 can perform operation by supplementarily using in combination or using the electric power from the external power generation device 30.

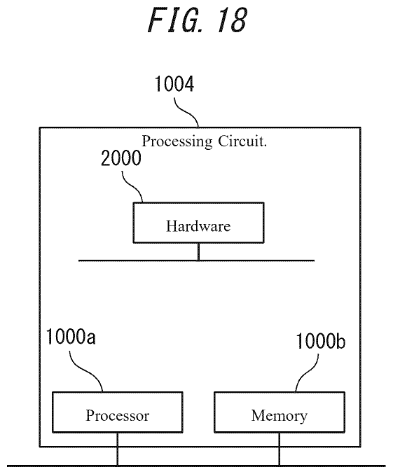

Next, an example of hardware constituting the analysis device 1004 will be described by using FIG. 18.

FIG. 18 is a hardware configuration diagram of an analysis device of the raising/lowering device information collection system in embodiment 1.

Each function of the analysis device 1004 can be realized by a processing circuit. For example, the processing circuit includes at least one processor 1000a and at least one memory 1000b. For example, the processing circuit includes at least one dedicated hardware 2000.

When the processing circuit includes at least one processor 1000a and at least one memory 1000b, each function of the analysis device 1004 is realized by software, firmware, or a combination of software and firmware. At least one of software and firmware is described as a program. At least one of the software and the firmware is stored in the at least one memory 1000b. The at least one processor 1000a realizes each function of the analysis device 1004 by reading and executing the program memorized in the at least one memory 1000b. The at least one processor 1000a is also referred to as a central processing unit, a processing unit, an arithmetic operation unit, a microprocessor, a microcomputer, and a DSP. For example, the at least one memory 1000b is a nonvolatile or volatile semiconductor memory such as a RAM, ROM, flash memory, EPROM, and EEPROM, a magnetic disk, a flexible disk, an optical disk, a compact disk, a minidisk, a DVD and the like.

When the processing circuit includes at least one dedicated hardware 2000, the processing circuit is realized in, for example, a single circuit, a composite circuit, a programed processor, a parallel-programed processor, ASIC, EPGA, or a combination of these. For example, each function of the analysis device 1004 is realized in the processing circuit. For example, each function of the analysis device 1004 is collectively realized in a processing circuit.

For each function of the analysis device 1004, a part of it may be realized in the dedicated hardware 2000, and the other part may be realized in software or firmware. For example, the function of causing the indication device 1003 to indicate information is realized in the processing circuit as the dedicated hardware 2000, and the other functions than this may be realized by the at least one processor 1000a reading and executing the program stored in the at least one memory 1000b.

In this way, the processing circuit realizes each function of the analysis device 1004 in the hardware 2000, software, firmware or a combination thereof.

Though not illustrated, each function of the transmission unit 25 of the wireless sensor 21 or the gateway device 22 may also be realized in a processing circuit equivalent to the processing circuit that realizes each function of the analysis device 1004.

### INDUSTRIAL APPLICABILITY

As above, the wireless sensor according to the present disclosure can be used in an elevator system.

### REFERENCE SIGNS LIST

1 hoistway, 2 building, 3 machine room, 4 hall, 5 hatch door, 6 traction machine, 7 car, 7a car door, 8 control device, 9 remote communication device, 10 information center device, 11 communication line network, 12 safety circuit, 13 contact, 13a first contact, 14 power supply, 15 detector, 16 conducting wire, 17 communication line, 18 power supply line, 20 raising/lowering device information collection system, 21 wireless sensor, 22 gateway device, 23 signal detection unit, 24 power acquisition unit, 25 transmission unit, 30 external power generation device, 101 signal processing circuit, 102 voltage attenuating resistor, 103 amplifier, 104 contact voltage monitoring line, 105 acquisition circuit, 106 diode bridge, 107 constant voltage circuit, 108 non-stable power supply line, 109 stable power supply line, 110 load-side capacitor, 111 storage voltage dividing resistor, 112 storage voltage monitoring line, 113 constant voltage side capacitor, 114 first high speed charging capacitor, 115 second high speed charging capacitor, 116 first trickle charging resistor, 117 second trickle charging resistor, 118 power reception circuit, 119 processing circuit, 120 wireless circuit, 121 ROM, 122 RAM, 123 MCU core, 124 first ADC circuit, 125 second ADC circuit, 126 antenna, 201 temporary memory unit, 202 power supply unit, 203 processing unit, 204 ROM, 205 RAM, 206 MCU core, 207 memory unit communication I/F, 208 wireless circuit, 209 external communication I/F, 210 antenna, 801 control circuit, 802 remote communication I/F, 901 power supply I/F, 902 GW communication I/F, 903 control device communication I/F, 904 line network communication I/F, 1000a processor, 1000b memory, 1001 memory device, 1002 communication device, 1003 indication device, 1004 analysis device, 2000 hardware, N negative side bus, P positive side bus.

1. A wireless sensor that measures a condition of a first contact included in a safety circuit in which a plurality of contacts are connected in series in a raising/lowering device, comprising:
a signal detection circuitry to detect an electrical signal indicating a condition of a voltage of the first contact;
a power acquisition circuitry to obtain power from the safety circuit when the first contact is open; and
a transmission circuitry to operates by the power obtained by the power acquisition circuitry, and to transmit a radio wave indicating the electrical signal detected by the signal detection circuitry.

2. The wireless sensor according to claim 1,
wherein the power acquisition circuitry includes
an acquisition circuit that is connected in parallel with the first contact, to the safety circuit, and obtains power from the safety circuit when the first contact is open.

3. The wireless sensor according to claim 2,
wherein the circuitry includes
a first high speed charging capacitor connected in series between the first contact and the acquisition circuit.

4. The wireless sensor according to claim 3, wherein the first high speed charging capacitor has a characteristic that it stores power to have a high resistance value from a low resistance value in a time shorter than a detection delay time until the safety circuit detects opening of the first contact, when the first contact is opened from a closed condition.

5. The wireless sensor according to claim 3, wherein the first high speed charging capacitor is a capacitor in which a basic failure mode is being in an open condition.

6. The wireless sensor according to claim 3,
wherein the power acquisition circuitry includes
a trickle charging resistor connected in parallel with the first high speed charging capacitor, between the first contact and the acquisition circuit, and
the acquisition circuit obtains power from the safety circuit via the trickle charging resistor when the first contact is open.

7. The wireless sensor according to claim 6, wherein when the first contact is opened from a closed condition, a total value of a value of a current flowing in the first high speed charging capacitor and a value of a current flowing in the trickle charging resistor becomes smaller than a detection threshold of a current value for detecting that the first contact is opened in the safety circuit in a time shorter than a detection delay time until the safety circuit detects opening of the first contact.

8. The wireless sensor according to claim 3,
wherein the power acquisition circuitry
includes a second high speed charging capacitor connected in series between a negative side of the first contact and the acquisition circuit, and
the first high speed charging capacitor is connected in series between a positive side of the first contact and the acquisition circuit.

9. The wireless sensor according to claim 2, wherein the acquisition circuit includes a power storage capacitor connected in parallel with the first contact to the safety circuit.

10. The wireless sensor according to claim 1, wherein the signal detection circuitry detects an electrical signal indicating whether the first contact is in an open condition or a closed condition, as a condition of a voltage of the first contact.

11. The wireless sensor according to claim 1, wherein the signal detection circuitry detects an electrical signal indicating change in voltage values at both ends of the first contact at a time when the first contact is closed from an open condition as a condition of a voltage of the first contact.

12. The wireless sensor according to claim 1,
wherein the signal detection circuitry includes
a signal processing circuit connected in parallel with the first contact to the safety circuit,
a voltage attenuating resistor connected in series between the first contact and the signal processing circuit, and
an amplifier connected between the signal processing circuit and the transmission circuitry,
the signal processing circuit processes and converts a current from the voltage attenuating resistor into the electrical signal indicating a condition of a voltage of the first contact, and
the amplifier amplifies the electrical signal processed and converted by the signal processing circuit and inputs the electrical signal to the transmission circuitry.

13. A raising/lowering device information collection system, comprising:
a wireless sensor that operates by power obtained from a safety circuit when a first contact included in the safety circuit in which a plurality of contacts are connected in series opens in a raising/lowering device, and transmits a radio wave indicating an electrical signal indicating a condition of a voltage of the first contact during operation; and
a gateway device that creates information on the first contact based on the radio wave received from the wireless sensor, and transmits the information on the first contact to a remote communication device.

14. The raising/lowering device information collection system according to claim 13, wherein the wireless sensor is connected to the safety circuit to be parallel with a contact group in both ends of the contact group comprising two or more contacts connected in series and including the first contact of the plurality of contacts.

15. The raising/lowering device information collection system according to claim 14, wherein when receiving the radio wave indicating that any of the contacts included in the contact group is opened, the gateway device determines which contact included in the contact group the opened contact indicated in the radio wave is, based on position information of a car acquired from a control device of the raising/lowering device.

16. The raising/lowering device information collection system according to claim 13, wherein the gateway device diagnoses soundness of the first contact based on the radio wave, and transmits a diagnosis result in association with the information on the first contact.

17. The raising/lowering device information collection system according to claim 13, comprising:
an information center device that receives the information on the first contact via the remote communication device from the gateway device, and diagnoses soundness of the first contact based on the information on the first contact.
